(19) United States
(12) Patent Application Publication
(10) Pub. No.: US 2013/0112045 A1
(43) Pub. Date: May 9, 2013

(54) SLEDGE HAMMER WITH SLOT FOR HALLIGAN TOOL

(71) Applicant: CHRIS PIVERONAS, Montana, CA (US)

(72) Inventor: CHRIS PIVERONAS, Montana, CA (US)

(21) Appl. No.: 13/288,835

(22) Filed: Nov. 3, 2011

(51) Int. Cl. B25D 1/14

(52) U.S. Cl. 81/26

(57) ABSTRACT

A sledge hammer having a handle and a double-face head. The head may be secured to one end of the handle and have a horizontal slot formed through a top portion perpendicular to a line between the two faces. The slot may be configured to receive an adze blade of a Halligan tool.

### BACKGROUND OF THE INVENTION

The present invention generally relates to a sledge hammer type striking tool that has a slot built into the head so the adze blade of a Halligan-type pry bar can slide through the slot and be married to the sledge hammer to enable a person to carry both tools with one hand.

A Halligan bar (or Halligan tool) is a multi-purpose tool used frequently by firemen and other law enforcement personnel, particularly to help during a forcible entry. It typically has a claw or fork at one end and a wedge or adze blade and a pick at the other end. Sledge hammer striking tools are also often used by firemen and other law enforcement personnel. However, because of their size, a person generally can only carry a sledge hammer or a Halligan bar but it may be difficult or awkward to carry both at the same time.

### SUMMARY OF THE INVENTION

In one aspect of the present invention, a sledge hammer includes a handle and a double-faced head. The head may be secured to one end of the handle and have a horizontal slot formed through a top portion perpendicular to a line between the two faces. The slot may be configured to receive an adze blade of a Halligan tool.

In another aspect of the present invention, an apparatus includes a hammer head with a trapezoidal slot formed through the hammer head. The trapezoidal slot may be configured to receive an adze blade of a Halligan tool.

These and other features, aspects and advantages of the present invention will become better understood with reference to the following drawings, description and claims.

### BRIEF DESCRIPTION OF THE DRAWINGS

FIG. 1 is a perspective view of an exemplary embodiment of a sledge hammer of the present invention married to a Halligan tool;

FIG. 2 is a perspective view of the sledge hammer of FIG. 1 separated from the Halligan tool;

FIG. 3 is a perspective view of an alternate embodiment of a sledge hammer of the present invention married to a Halligan tool;

FIG. 4 is a perspective view of the sledge hammer of FIG. 3 separated from the Halligan tool;

FIG. 5 is a perspective view of the head of the sledge hammer of FIG. 1;

FIG. 6 is a side view of the head of the sledge hammer of FIG. 1;

FIG. 7 is a side view of the head of the sledge hammer of FIG. 3; and

FIG. 8 is an exploded view of the head of the sledge hammer of FIG. 3.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, embodiments of the present invention generally provide a sledge hammer type striking tool that has a slot built into the head so the adze end of a Halligan bar may slide through the slot and be married to the sledge hammer, enabling a person to carry both tools with one hand.

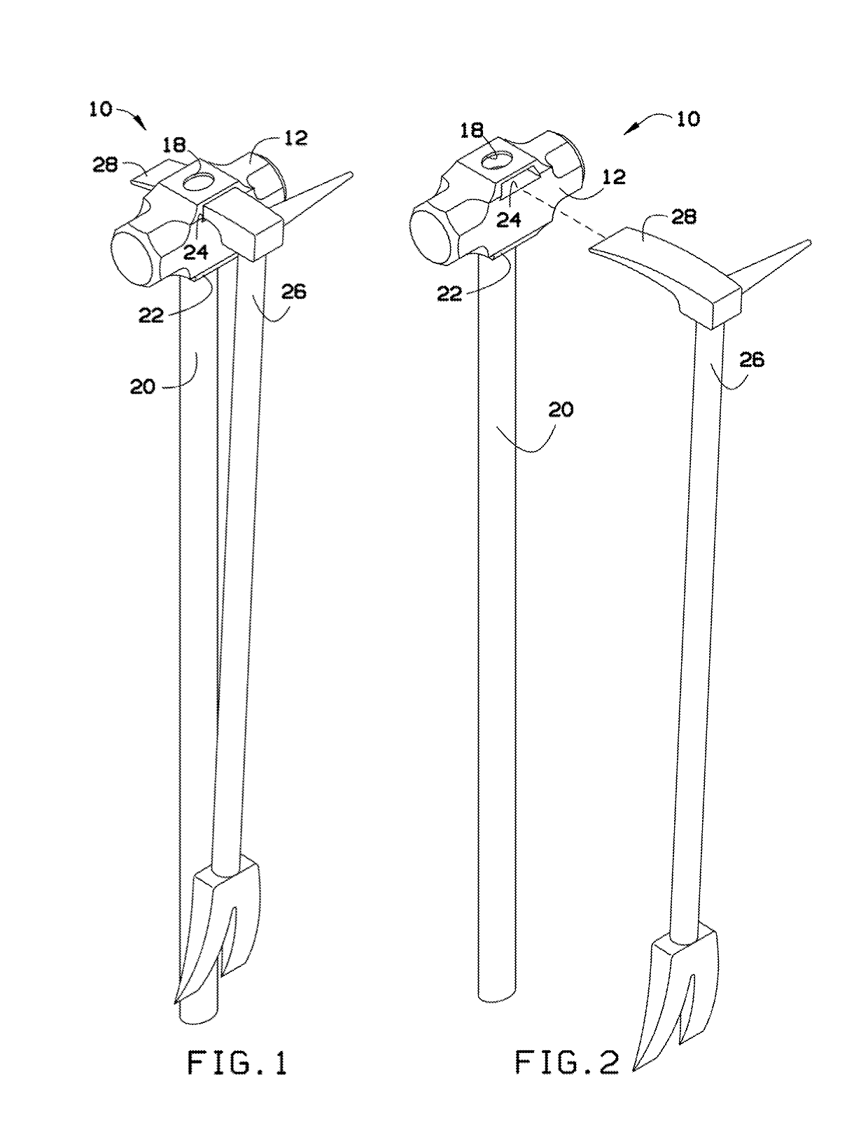

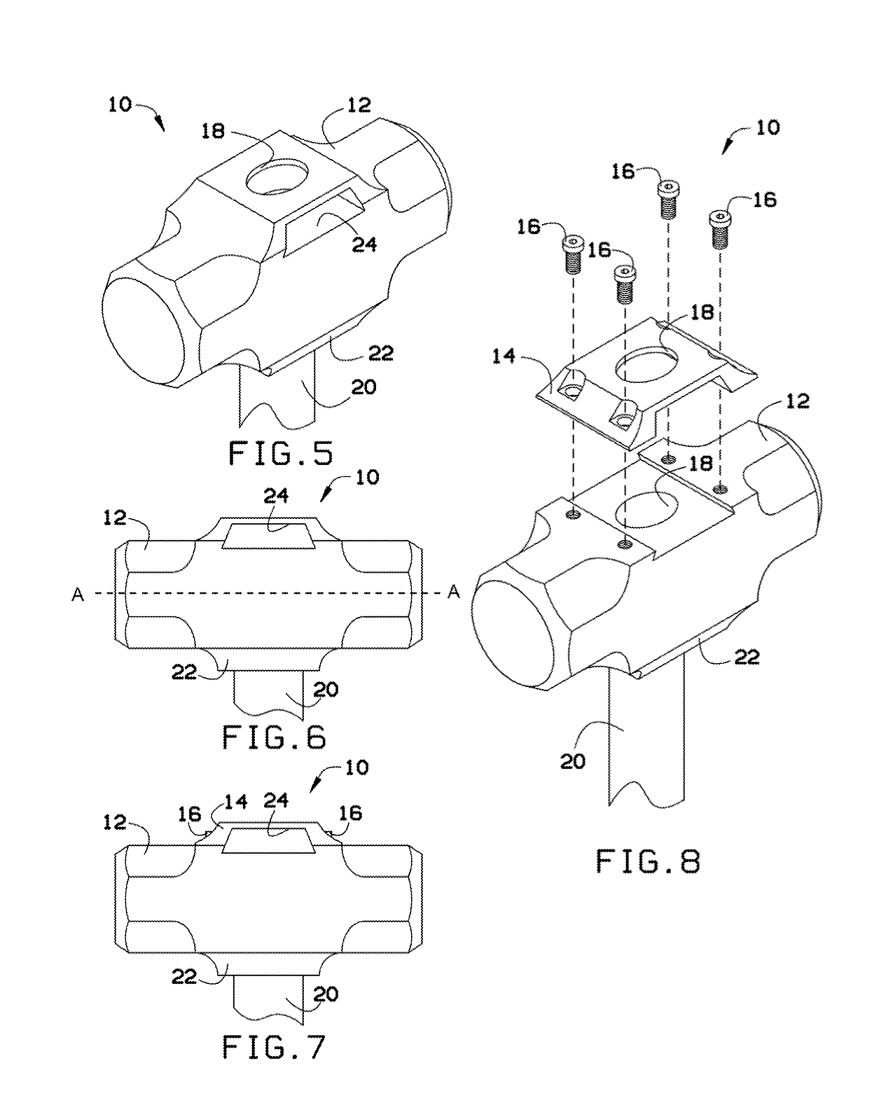

Referring to FIGS. 1, 2, 5, and 6, an embodiment of the sledge hammer type striking tool 10 may include a double-faced hammer head 12 and a handle 20. The head 12 may have a horizontal slot 24 formed through a top portion of the head 12 perpendicular to a line A-A (FIG. 6) between the two faces. The slot may be sized and shaped, such as trapezoidal, to receive the adze blade 28 of a Halligan tool 26 to marry the two tools 10, 26 together. The head 12 may also have a hole 18 formed through the top surface that may be used to drill out the remains of the handle 20 if the handle 20 breaks. When the adze blade 28 of the Halligan tool 26 is inserted into the slot 24, the claw or fork at the other end of the Halligan tool 26 may rest against the lower end of the hammer handle 20.

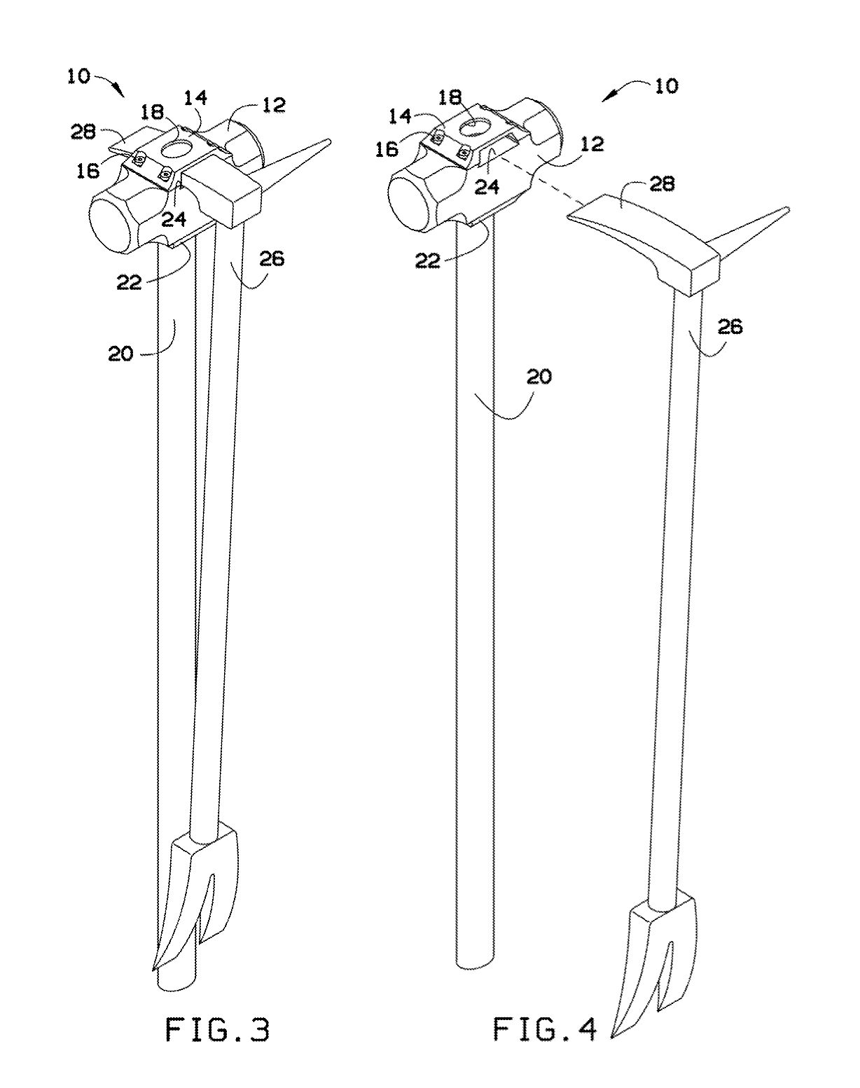

As illustrated in FIGS. 5 and 6, the head 12, with the slot 24, may be fabricated in one piece. Alternatively, as illustrated in FIGS. 7 and 8, a top plate 14 may be secured to the top surface of the hammer head 12 with screws 16 with the slot 24 formed under the top plate 14 to hold the adze blade 28 to the hammer head 12 as shown in FIGS. 3 and 4.

The head 12 may have a reinforcing flange 22 extending downward from the bottom surface of the head 12 to help protect and strengthen the handle 20. The flange 22 may also provide a larger surface area of the head 12 for contact with the handle 20 to compensate for decreased contact at the top of the head where the slot 24 is located.

The hammer head 12 may be fabricated by machining or casting metal into the desired shape or by any other appropriate method. The head 12 may be attached to the handle 20 with wedges, glue, or any other appropriate method.

To use, the adze blade of a Halligan tool 26 may be inserted into the slot 24 of the hammer head 12 to marry the two tools 10, 26. The two tools 10, 26 may then be carried securely in one hand. The two tools 10, 26 may be quickly separated when necessary by slipping the adze blade 28 from the slot 24.

It should be understood, of course, that the foregoing relates to exemplary embodiments of the invention and that modifications may be made without departing from the spirit and scope of the invention as set forth in the following claims.

What is claimed is:

1. A sledge hammer, comprising:
a handle; and
a double-faced head secured to one end of the handle, the head having a horizontal slot formed through a top portion perpendicular to a line between the two faces and configured to receive an adze blade of a Halligan tool.

2. The sledge hammer of claim 1, further comprising a top plate secured to a top surface of the head, the horizontal slot being formed under the top plate.

3. The sledge hammer of claim 2, wherein the top plate is secured to the top surface with screws.

4. The sledge hammer of claim 1, wherein the double-faced head is fabricated in one piece.

5. The sledge hammer of claim 1, wherein the horizontal slot is trapezoidal.

6. The sledge hammer of claim 1, the head further comprising a reinforcing flange extending downward from a bottom surface of the head.

7. The sledge hammer of claim 1, further including a hole formed through a top surface of the double-faced head.

8. An apparatus, comprising:
a hammer head; and
a trapezoidal slot formed through the hammer head, the trapezoidal slot configured to receive an adze blade of a Halligan tool.

9. The apparatus of claim 8, further including a reinforcing flange extending downward from a bottom surface of the hammer head.

10. The apparatus of claim 8, wherein the hammer head is double-faced.
